(19) United States
(12) Patent Application Publication
(10) Pub. No.: US 2013/0153580 A1
(43) Pub. Date: Jun. 20, 2013

(54) Paint Tray

(71) Applicants: Curt D. Marino, Moon Twp., PA (US); Eric P. Tierney, Crescent, PA (US); Tony J. Barcia, Pittsburgh, PA (US); John Bundy, Wexford, PA (US)

(72) Inventors: Curt D. Marino, Moon Twp., PA (US); Eric P. Tierney, Crescent, PA (US); Tony J. Barcia, Pittsburgh, PA (US); John Bundy, Wexford, PA (US)

(73) Assignee: American Metal Products, Moon Twp, PA (US)

(21) Appl. No.: 13/525,962

(22) Filed: Jun. 18, 2012

Related U.S. Application Data
(60) Provisional application No. 61/497,714, filed on Jun. 16, 2011.

(51) Int. Cl. B05C 21/00

(52) U.S. Cl. CPC B05C 21/00
USPC 220/570

(57) ABSTRACT

A paint tray includes a tray body, at least one support structure, and an attachment arrangement adapted for attaching the at least one support structure to at least one of an object and surface.

### CROSS REFERENCE TO RELATED APPLICATIONS

This application claims benefit of priority from U.S. Provisional Patent Application No. 61/497,714, filed Jun. 16, 2011, which is incorporated herein by reference in its entirety.

### BACKGROUND OF THE INVENTION

1. Field of the Invention

The present invention relates generally to paint trays and, more specifically, to paint trays having an attachment arrangement for securing the paint tray to an object or surface.

2. Description of Related Art

The application of paint to large areas of a wall or ceiling is preferably accomplished with the use of a paint roller and tray. A conventional tray is typically made from metal or plastic and is generally rectangular in shape. The typical tray is defined by four sidewalls and a base. The trays include a reservoir at one end to contain a substance, e.g., paint or stain, to be applied. A roller is dipped into the substance in the reservoir, and the substance is distributed onto the roller by moving the roller over a sloped section of the tray. The sloped section of the tray often contains ribs that facilitate the even application of paint to the roller. The ribbed section of the tray is sloped upwards away from the reservoir to an elevated end in a manner that facilitates the return of excess paint to the reservoir on the bottom. The elevated end is typically supported by L-shaped legs, which allow the tray to be stable on a flat surface and permit removable attachment of the tray to a ladder.

Such trays are well known in the art as shown, for example, in U.S. Pat. Nos. 4,102,468; and 3,729,764, and U.S. Patent Application Publication No. 2008/0127443. However, these existing trays are associated with numerous deficiencies and drawbacks in use and application. One of the most common problems is the clean-up associated with such existing paint trays. During a common event of painting, extended periods of non-use are common, particularly while a user waits for one coat of paint to dry. During these periods, it is common for the paint within the tray to clump and dry, particularly on the sloped, ribbed section of the tray and the sidewalls. This can result from the nature of the material from which the tray is formed, slow drainage, and from leaving the tray out for too long after painting has concluded. Cleaning a tray following such extended periods of drying is time consuming and results in a significant waste of material.

Various solutions have been proposed in an attempt to effectively address the problem of dried paint in the tray. However, each presents its own undesirable problem. For example, disposable liners have been disclosed and recited in the art, such as in U.S. Pat. Nos. 7,721,910; and 7,004,348. Disposable liners present their own unique problems, including increased refuse, the need to purchase additional supplies, such as double-sided tape, and, in the case of U.S. Pat. No. 7,721,910, which is manufactured with a plurality of liners already installed on the tray, the eventuality that the liners will be depleted, leaving a regular paint tray without a non-stick surface. Yet another example is the wholly disposable tray, such as in U.S. Pat. Nos. 3,858,787; and 7,484,637. Disposable trays create even more refuse than disposable tray liners, and such trays are, for cost reasons, usually plastic or cardboard, resulting in less strength than would be present in a metallic or other structurally-rigid tray. Such trays also ordinarily do not have legs for securing to a surface, such as a ladder, and owing, to the construction material, would not be suited for such uses.

Another problem with many prior trays is that they lack a means by which a paint roller can be engaged to prevent the handle from falling into the paint tray when the roller is resting in the tray and not in use, or when the tray is moved while the roller is resting in the tray. Some mechanisms are known in the art as seen, for example, in U.S. Pat. No. 7,083,044. However, such a mechanism resides inside the paint tray and thus may still expose the handle and the neck of the roller to paint. Another mechanism is disclosed in U.S. Pat. No. 3,707,242. However, such a mechanism does not permit the paint roller handle to removably engage with the tray and, thus, to be more secure when the tray is moved.

Yet another problem with prior trays is the difficulty in securing the trays to a ladder when use of a roller is required at heights. This problem has been addressed by others as shown, for example, in U.S. Pat. No. 3,707,242. However, orienting the tray in a predominantly vertical manner raises other issues in applying paint to the roller, and the nature of the tray surface and the shape of the tray result in difficulties in cleaning the tray after use. While an embodiment of that tray may be secured horizontally, it involves the additional step of securing a rope or chain around the rung of a ladder, and the means for securing the tray to the top of a ladder lacks stability. U.S. Pat. No. 4,205,411 describes a connection of a paint tray to a ladder in a horizontal position. However, the tray, as disclosed, is made of plastic and thus lacks the necessary strength to prevent malformation and buckling when the tray is filled with paint. Further, the thin metal bail is likewise vulnerable to malformation when forces are exerted on the tray, such as during movement while the tray is attached to a ladder. Lastly, the tray is difficult to clean after use.

Trays having non-stick surfaces have been described in the art, such as in U.S. Patent Application Publication No. 2007/0199942. However, the described arrangement lacks an optimal design to compliment the non-stick surface.

### SUMMARY OF THE INVENTION

It is, therefore, an object of the present invention to address some or all of the deficiencies in the prior art. According to one preferred and non-limiting embodiment of the present invention, provided is a paint tray including: a tray body; at least one support structure; and an attachment arrangement adapted for attaching the at least one support structure to at least one of an object and a surface.

According to another preferred and non-limiting embodiment of the present invention, provided is a paint tray, including: a tray body having a rim and a bottom surface, wherein the rim comprises a substantially rigid portion; and a plurality of substantially rigid ribs disposed on at least a portion of the bottom surface of the tray body.

According to a further preferred and non-limiting embodiment of the present invention, provided is a securable paint tray, including: a tray body having a sloped region, a reservoir region, and a rim, wherein at least a portion of the sloped region and/or reservoir region include a non-stick material; a wire disposed within at least a portion of the rim; and at least one support structure in the form of an attachment arrangement.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 illustrates a top view of a paint tray according to the principles of the present invention;

FIG. 2 illustrates a front view of the paint tray of FIG. 1 according to the principles of the present invention;

FIG. 3 illustrates a perspective view of the paint tray of FIG. 1 according to the principles of the present invention;

FIG. 4 illustrates a side view of the paint tray of FIG. 1 according to the principles of the present invention;

FIG. 5 illustrates a perspective view of a support structure of a paint tray according to the principles of the present invention;

FIG. 6 illustrates a side view of the support structure of FIG. 5 according to the principles of the present invention;

FIG. 7 illustrates a front view of the support structure of FIG. 5 according to the principles of the present invention;

FIG. 8 illustrates a top view of the support structure of FIG. 5 according to the principles of the present invention;

FIGS. 9a and 9b illustrate sectional views of a paint tray and paint roller according to the principles of the present invention;

FIG. 9c illustrates a side-view of the paint tray shown in FIG. 9b;

FIG. 10 illustrates a ladder including an attached paint tray according to the principles of the present invention;

FIGS. 11a-11h illustrate a support structure and attachment arrangement of a paint tray according to the principles of the present invention;

FIG. 12a illustrates a top view of a paint tray having a retaining mechanism according to the principles of the present invention;

FIG. 12b illustrates a sectional view taken along the line A-A of FIG. 12a according to the principles of the present invention;

FIG. 12c illustrates a side view of a paint tray having a retaining mechanism according to the principles of the present invention;

FIG. 12d illustrates a sectional view taken along the line B-B of FIG. 12c according to the principles of the present invention;

FIG. 13a illustrates a side view of a paint tray having a retaining mechanism and a paint roller according to the principles of the present invention;

FIG. 13b illustrates a top view of a paint tray having a retaining mechanism and a paint roller according to the principles of the present invention; and

FIG. 13c illustrates a perspective view of a paint tray having a retaining mechanism and a paint roller according to the principles of the present invention.

### DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

According to one preferred and non-limiting embodiment of the present invention, a paint tray 10 includes a tray body 100, support structures 121 for supporting the tray body 100, and an attachment arrangement 110 for securing the tray body 100, the support structures 121, or both, to a ladder or other object or surface. In one example, the support structures 121 may include one or more substantially L-shaped legs 104, 105 connected to the tray body 100, although it will be appreciated that a number of different types of legs, including legs that are connected to the tray body 100 and legs that are integrated with the tray body 100, may be used to support the tray body 100. In a preferred embodiment, the L-shaped legs 104, 105 are adapted to receive a top step or rung of a ladder, or other like object or surface.

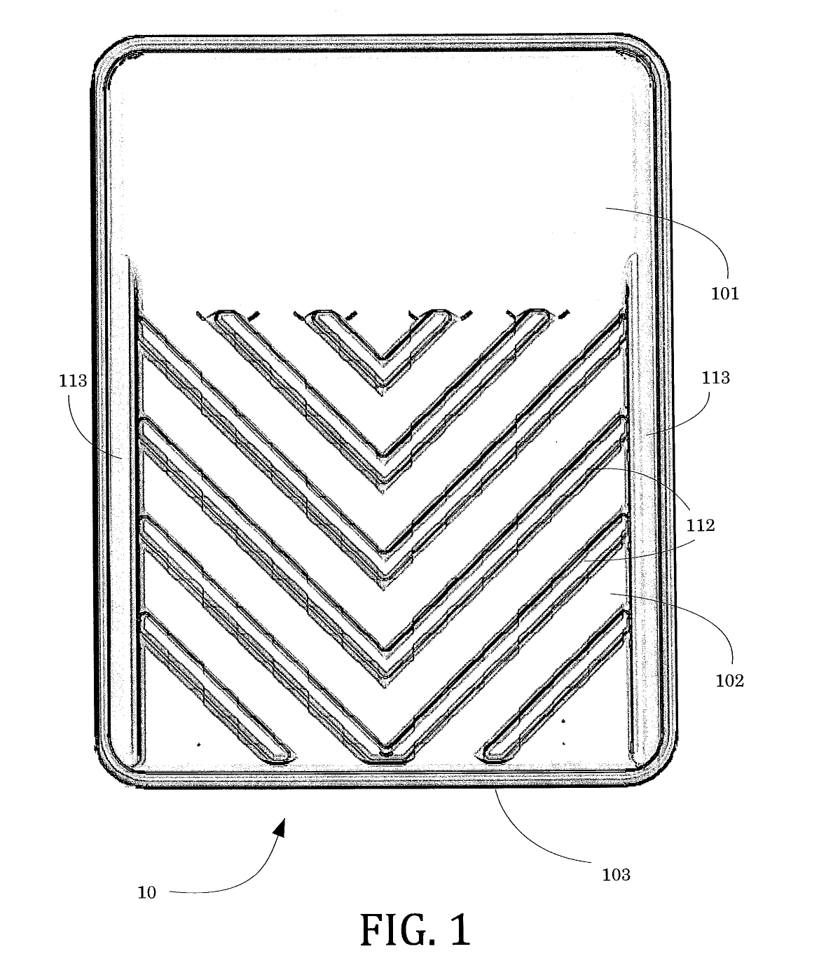

Referring now to FIGS. 1, 3, and 4, a paint tray 10 is shown according to one preferred and non-limiting embodiment of the present invention. It is envisioned that, while (as discussed hereinafter) reference is made to a “paint” tray, any type of fluid for application can be used in connection with the paint tray, e.g., paint, lacquer, varnish, a coating, an adhesive, a liquid, and the like. In one preferred and non-limiting embodiment, the paint tray 10 includes a tray body 100 having inner surfaces 122, including a bottom surface 125 that includes a reservoir portion 101 and a sloped portion 102. The sloped portion 102 is angled with respect to a surface or object that the paint tray body 100 is rested upon (i.e., the seated position of the paint tray), such that paint or other substances flow toward the reservoir portion 101. The reservoir portion 101 retains paint or other substances and is of a width sufficient to receive a paint roller or other application device, e.g., a brush, a cloth, a sponge applicator, and the like.

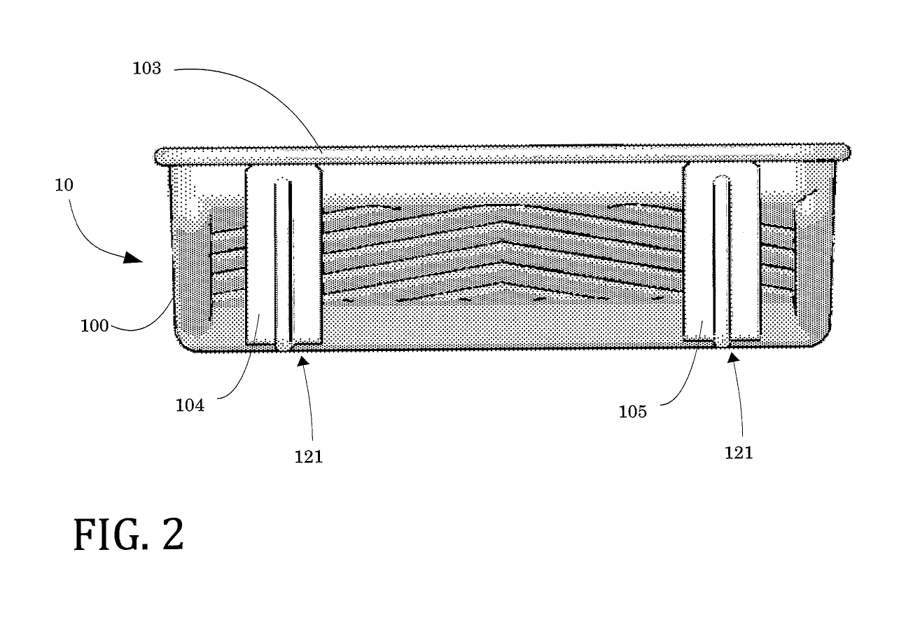

Referring to FIGS. 2-4, the paint tray 10 includes support structures 121. In a preferred and non-limiting embodiment, the support structures 121 are in the form of substantially L-shaped legs 104, 105 connected to the tray body 100 adjacent an upper end of the sloped portion 102. In another preferred and non-limiting embodiment, the L-shaped legs 104, 105 are adapted to be hooked on or otherwise coupled to a top step or rung of a ladder, or any other like object or surface having an edge or ridge upon which the L-shaped legs 104, 105 may rest, or that the legs 104, 105 may receive or fit around. In a preferred and non-limiting embodiment, the support structures 121 are attached to the tray body 100, although it will be appreciated that they may also be integrated with, removably attached, and/or permanently attached to the tray body 100. The support structures 121 may also include various other types of legs, projections, protrusions, and members of various shapes, sizes, and configurations.

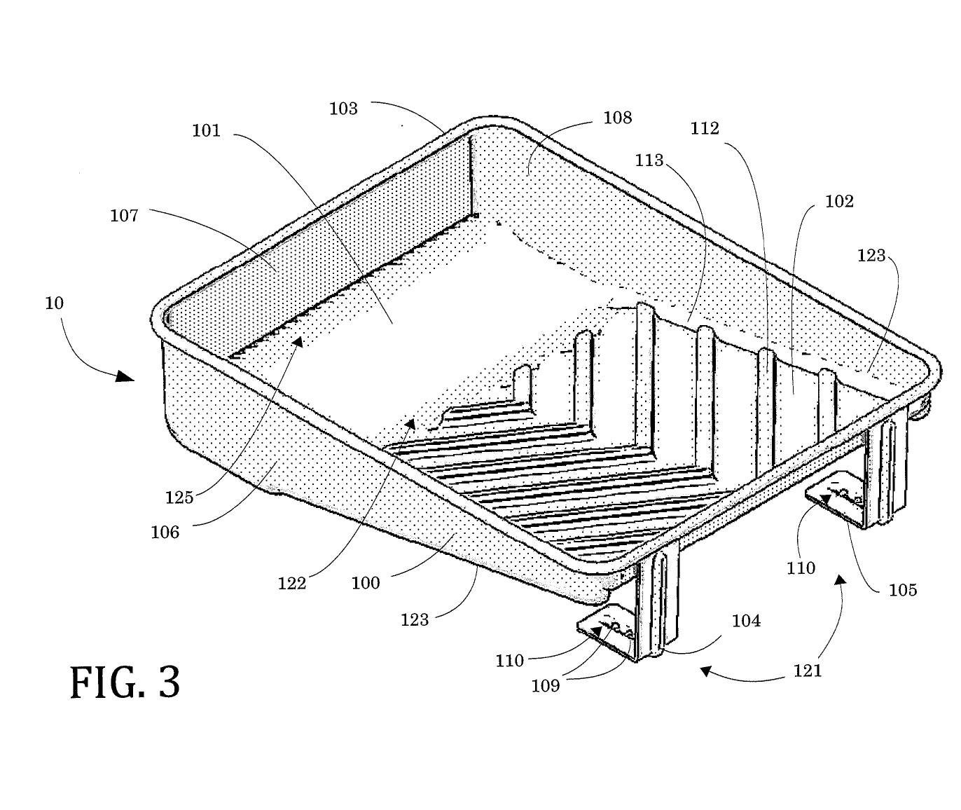

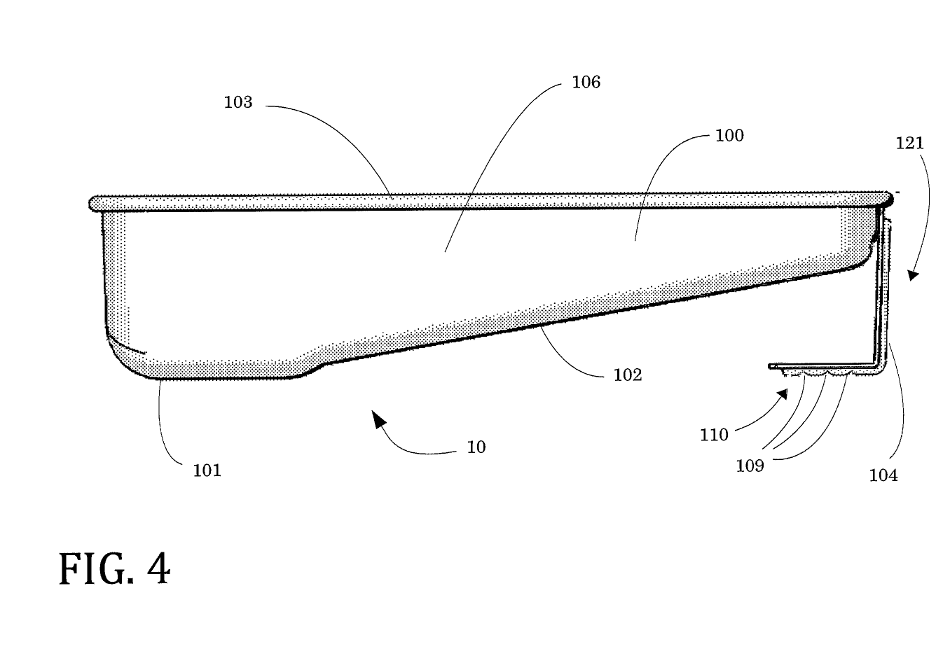

Referring now to FIGS. 3-4, the support structures 121 are shown to include an attachment arrangement 110. In a preferred and non-limiting embodiment, the attachment arrangement 110 includes one or more apertures 109 extending through the support structures 121 that are adapted to receive a pin or other attachment arrangements or assemblies for attaching the support structures 121 to an object or surface. The attachment arrangement 110 may further include a pin or other attachment arrangements or assemblies that are received within the aperture 109. In FIGS. 3-4, there are three apertures 109 in each of the support structures 121, although it will be appreciated that any number of apertures 109 may be used. In a preferred and non-limiting embodiment, the attachment arrangement 110 allows the support structures 121 to be attached or otherwise fastened to a top step or rung of a ladder. However, it will be appreciated that the attachment arrangement 110 may be used to attach support structures 121 and/or the tray 110 to any object and/or surface.

With continued reference to FIGS. 1-4, the tray body 100 further includes a rim 103 extending around at least a portion of the top edge perimeter of the sidewalls of the tray body 100. In a preferred and non-limiting embodiment, this rim 103 includes a substantially rigid portion or material that is connected to, adjacent to, part of, or encompassed within the top edge perimeter of the tray body. The substantially rigid portion may include a wire that extends around at least a portion of the top edge perimeter. However, it will be appreciated that the rim 103 may include a thicker portion of the tray body 100, itself, or a removable wire or material that is otherwise attached to the tray body 100. The rim 103 provides support for the tray body 100 when the tray body 100 is, for example, attached to a ladder with the support structures 121 and/or the attachment arrangement 110.

The rim 103 may additionally serve as an effective arrangement for maintaining a paint roller in a position outside the reservoir, or for hanging or suspending a paint roller from the tray body 100. For example, the rim 103 may be of sufficient size and shape so as to stop a paint roller from sliding into the paint-filled reservoir portion 102 of the tray body 100 by acting as a stop for the handle of the paint roller. In one preferred and non-limiting embodiment, the rim 103 includes a magnetic material or has magnetic properties to allow tools, such as paint rollers or brushes, to be magnetically attached. The magnetic material may include the wire, a separate magnet, or any other magnetized material.

Referring now to FIG. 3, the tray body 100 includes sidewalls 106, 107, 108 and inner surfaces 122, including a bottom surface 125. The inner surfaces 122 may include an interior surface of the sidewalls 106, 107, 108 and the bottom surface 125. The sidewalls 106, 107, 108 may be substantially perpendicular to the bottom surface 125 of the tray body 100. The bottom surface 125 of the tray body 100 may include the reservoir portion 101 and sloped portion 102. Opposing sidewalls 106, 108 may include an angled bottom edge 123 that conforms to the slope of the sloped portion 102 and is adjacent to paint return channels 113 that extend along the edges of the sloped portion 102 of the bottom surface 125.

In a preferred but non-limiting embodiment of the present invention, the tray body 100 is rectangular in shape with at least a portion thereof formed or manufactured by a metal material, such as steel or the like. The steel body may, for example, be constructed of a heavy gauge steel and/or aluminized steel. Aluminized steel may support various types of coatings that are not supported with plain steel, and increases the resistance to corrosion. In a preferred but non-limiting embodiment, the tray body 100 is constructed from 22 gauge (0.028″-0.030″) aluminized steel. However, various gauges may be used, such as 20-gauge, 24-gauge, 26-gauge, 28-gauge, etc. It will be appreciated that plain carbon steel may also be used, in addition to any other appropriate materials. Aluminized steel, as it is used herein, may refer to basic carbon steel with a thin coating of aluminum that, for example, ranges from 3-8 microns. In one embodiment, the tray body 100 is formed from a single sheet of material. In a preferred but non-limiting embodiment, the tray body 100 is approximately 14″ to 15″ in length, 11″ to 12″ in width, and 3″ to 4″ in height (e.g., depth).

Referring to FIGS. 1 and 3, the sloped portion 102 of the paint tray 10 includes a plurality of angled and substantially rigid ribs 112 that provide lateral structural support to the tray body 100 and aid in removing excess paint from the roller and evenly coating the roller in paint. The ribs 112, which are raised from the sloped portion 102 of the tray body 100, may be substantially large (e.g., raised and wide) enough to provide these attributes. The shape and width of the ribs 112 may provide support to the paint tray 10, and may enhance the attributes relating to removing excess paint and evenly coating the roller. Further, the ribs 112 may be sufficiently spaced so as to allow excess paint to flow to channels 113 adjacent the opposing sidewalls 106, 108. The channels 113 may be sufficiently deep and wide so as to aid in the quick and efficient return of excess paint to the reservoir portion 101. The efficient return of paint to the reservoir portion 110 minimizes the amount of dried paint that is left on the sloped portion 102, the ribs 112, and/or the paint return channels 113.

In a preferred and non-limiting embodiment, the ribs 112 are approximately 1/16″ to ⅜ ″ in height, and 1/16″ to ⅜″ in width. These specifications aid in efficient flow of paint or other substances, and ensure that the roller is sufficiently covered. In one embodiment, for example, the height of the ribs 112 measures 0.140″, the width measures 0.375″, and the return channels 113 range from 0.50″ to 0.875″ in depth and are curved to facilitate substance flow. Along the center of the tray body 100, the ribs 112 may meet at an angle, such as, for example, 90 degrees (e.g., 45 degrees from a center perpendicular bisector of the tray). However, it will be appreciated that the ribs 112 may take on various sizes and shapes, and may be arranged at various angles.

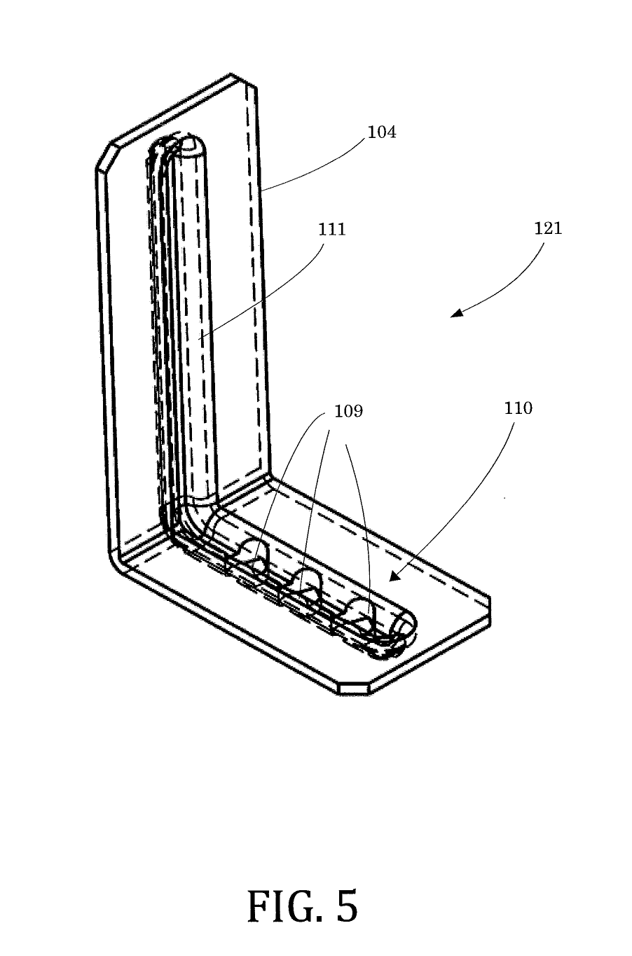

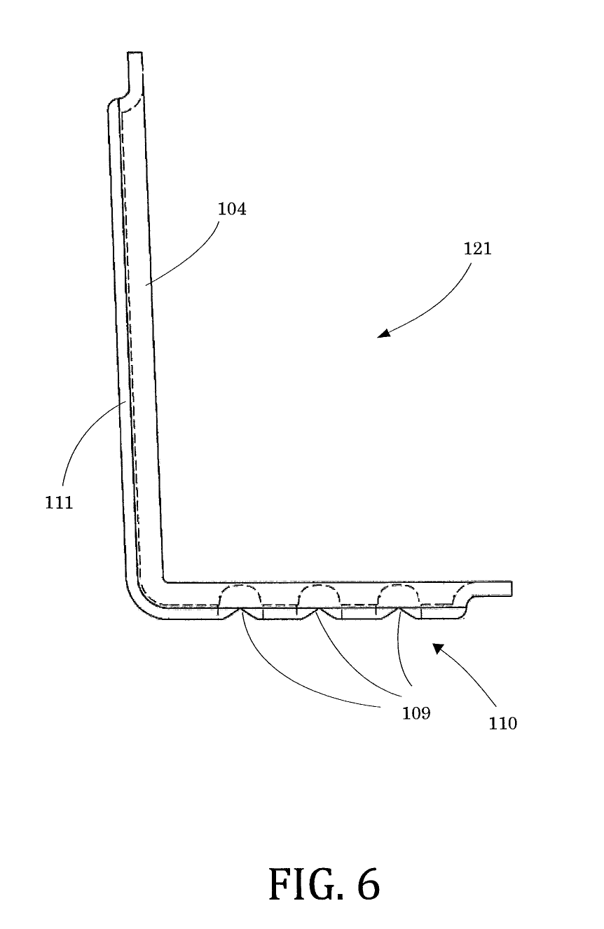

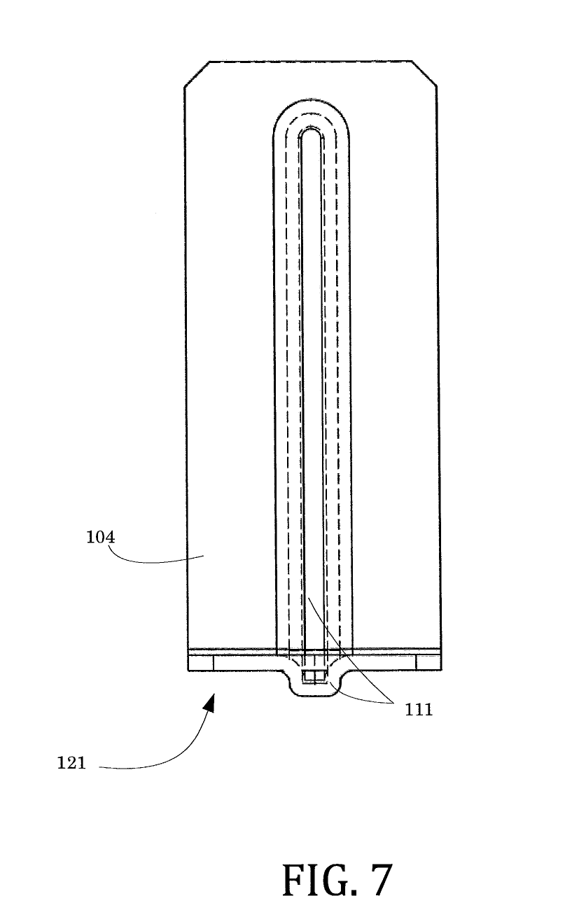

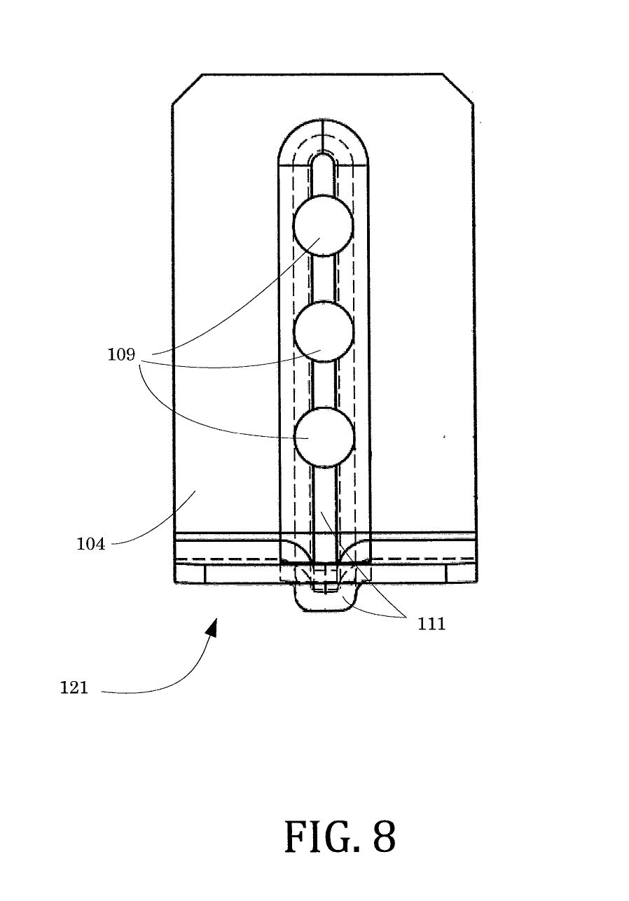

Referring now to FIGS. 5-8, illustrated is a support structure 121 according to one preferred and non-limiting embodiment of the present invention. The support structure 121 in this example comprises at least one substantially L-shaped leg 104, and is adapted to be fastened to the paint tray 10 and attached to an object or surface, such as a top step or rung of a ladder. The L-shaped leg 104 includes a central rib 111 that serves to provide further support, strength, and/or stability to the support structure 121. The L-shaped leg 104 also includes an attachment arrangement 110 for securing the supporting means 121 to an object or surface. In one preferred and non-limiting embodiment of the present invention, the L-shaped leg 104 is formed at least partially from 14-gauge (0.078″) aluminized steel, although other materials of other thicknesses may be used. The L-shaped leg 104 may be, for example, 1.25″ in width, over 3″ in height, and over 2″ in depth. The central rib 111, in one example, may be 0.25″ in width.

In one preferred and non-limiting embodiment of the present invention, the attachment arrangement 110 (in this embodiment, the L-shaped leg 104) includes a plurality of apertures 109 disposed on or near the central rib 111 of the L-shaped leg 104. The attachment arrangement 110 may further include a fastener or other like means for attaching or securing the support structure 104 to an object or surface. For example, a pin or screw may be used to attach the paint tray 10 to a top step or rung of a ladder that has a corresponding aperture or other means of attachment. In one preferred and non-limiting embodiment, the apertures 109 are approximately 0.25″ in diameter.

In another preferred and non-limiting embodiment, the inner surfaces 122 of the tray body 100, including but not limited to the bottom surface 125, the reservoir portion 101 and/or the sloped portion 102, is coated in or otherwise incorporates a non-stick material. The non-stick material allows for paint and other substances to be easily cleaned from the paint tray 10. It will be appreciated that, in addition to the inner surfaces 122, the entire tray body 100 may be coated in or otherwise incorporate a non-stick material. Further, in some embodiments, only a portion of the tray body 100, or only a portion of the inner surfaces 122, may include a non-stick material. In one embodiment, the non-stick material is a layer on the tray body 100 and/or inner surfaces 122 formed by applying a coating of the non-stick material; however, it should be appreciated that the non-stick material may be present over a more substantial portion of the tray body 100. The non-stick material may include, for example, polyetraflouroethylene (PFTE), perfluroalkoxy (PFA), a silicone polymer, and/or other non-stick compounds. The non-stick material has the advantage of allowing wet and dry paint and other substances used in the paint tray 10 to be easily removed.

The use of polytetrafluroethylene (PTFE) as a coating is preferred in one non-limiting embodiment of the present invention. PTFE has a high-molecular weight and consists wholly of carbon and fluorine. PTFE is hydrophobic; neither water nor water-containing substances can penetrate a coating of PTFE. PTFE is also preferable because it has low coefficients of friction. In another embodiment, commercial grade silicone is used, such as that used in bakeware. Commercial grade silicone may include low solids polysiloxane, which contains silanol functionality. The silanol functionality enables the material to be cross-linked and form a hard coating. Such a silicone coating has a composition similar to glass, with increased release properties. For example, Americoat XL is a fast curing, semi-permanent silicone coating with increased release properties and is designed for use on metal surfaces to increase non-stick characteristics. In a further embodiment, various graffiti-resistant paints may be used to coat at least a portion of the tray body 100.

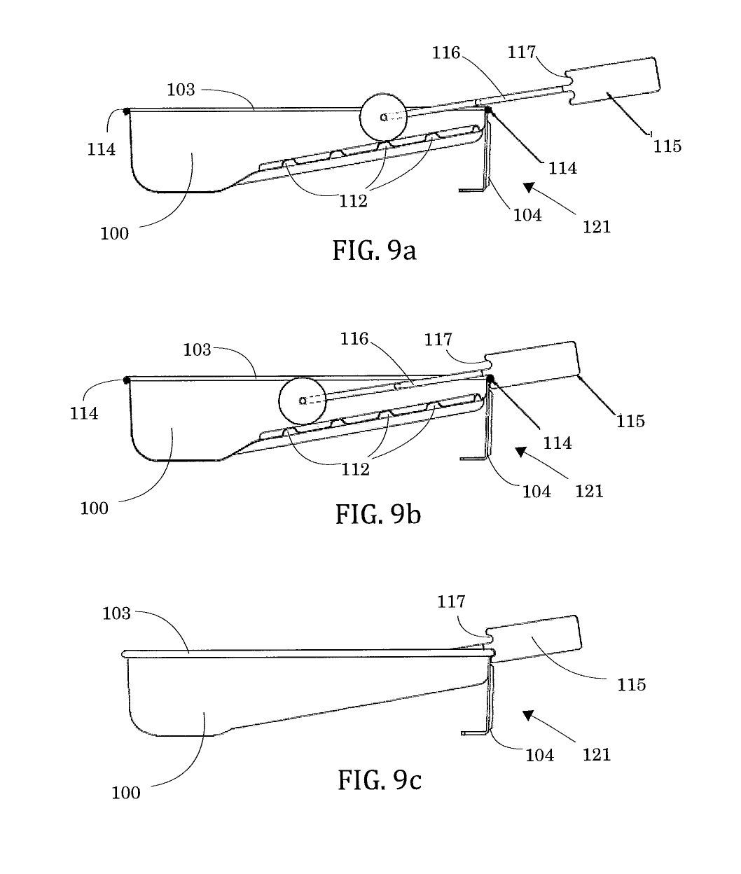

Referring now to FIGS. 9a-c, and in another preferred and non-limiting embodiment, illustrated is a paint tray body 100 and paint roller. The tray body 100 includes raised ribs 112, a rim 103, a rigid portion 114, and a support structure 104. The rigid portion 114 may be adjacent the rim 103, disposed on the rim 103, or contained within the rim 103. In one embodiment, the rigid portion 114 may be a wire. The paint roller 116 includes a handle 115 adapted with one or more grooves 117 to receive the rim 103 and/or rigid portion 114. With reference to FIG. 9a, a sectional view of a paint tray body 100 and paint roller 116 are shown, and the paint roller 116 is in a position on the sloped portion 102 and ribs 112.

With reference to FIGS. 9b and 9c, the paint roller 116 is on the sloped portion 102 of the tray body 100, but is in a position closer to the reservoir portion 101. Referring to FIG. 9c, the handle 115 prevents the paint roller 116 from reaching the reservoir region. The rim 103 and/or the rigid portion 114 is received by a groove 117 in the handle 115, or otherwise interacts with the handle 115, effectively holding the handle 115 in place. However, it will be appreciated that the handle 115 may be adapted in various other ways to engage the rim 103 and/or rigid portion 114, and the rim 103 may be adapted to stop an ordinary paint roller handle not equipped with grooves.

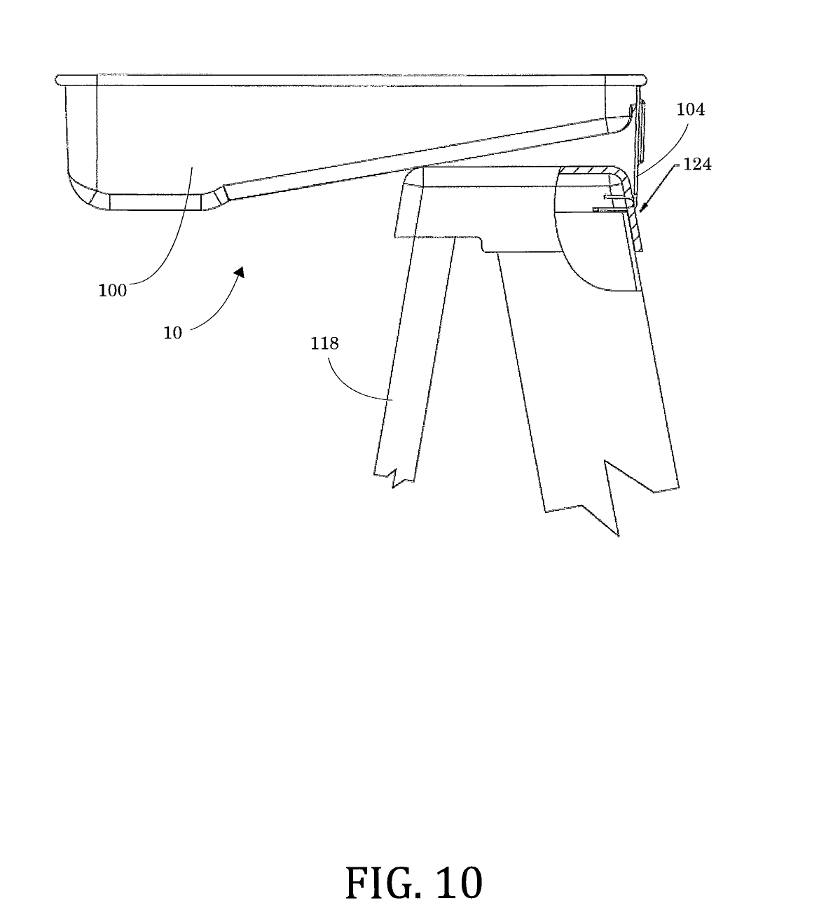

With reference to FIG. 10, the paint tray 10 is shown attached to a top step 124 of a ladder 118. In this example, a portion of the support structure 104 is received by the ladder 118 and is secured with an attachment arrangement 110 (not shown). Once the support structure 104 is secured to the top step 124, the ladder 118 and tray body 100 may be moved together without risking the tray body 100 falling off. In addition to being attached to the top step 124 of the ladder 118 as shown in FIG. 10, it will be appreciated that the support structure 104 may be attached to other parts of a ladder 118, such as a lower rung, or other objects and/or surfaces.

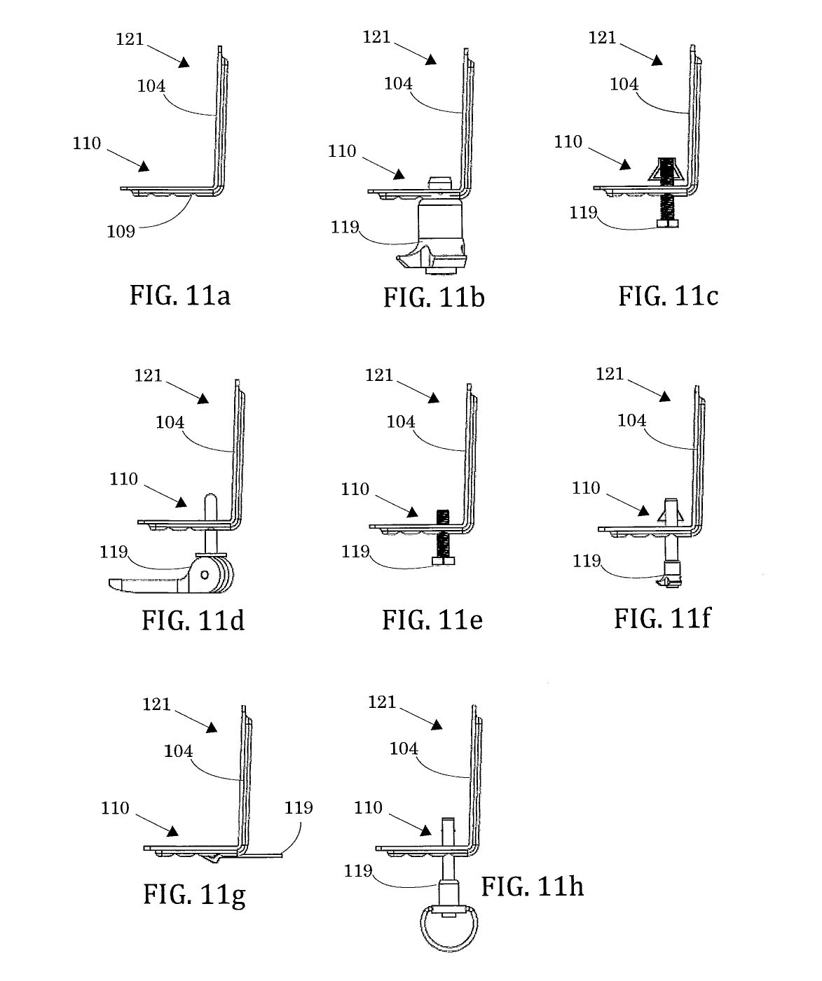

Now referring to FIGS. 11a-h, the support structure 104 that is used to attach the tray body 100 to the ladder 118 is shown according to various non-limiting embodiments. FIG. 11a shows a support structure 104 having an attachment arrangement 110 comprising apertures 109. FIGS. 11b-h illustrate attachment arrangements 110 comprising various fasteners (fastening members, arrangements, and/or mechanisms) 119, to be used in combination with the apertures 109. The fasteners 119 to be used in combination with the apertures 109 may include, for example, a pin, screw, carriage bolt, bolt, bolt and locking nut, quick-release assembly/mechanism, or other means. In one embodiment, the fastener 119 comprises Kwik-Loc™ pins available from the Jergens Manufacturing Efficiency or ball lock pins available from Carr Lane. It will be appreciated that the attachment arrangement 110 may also take on many other forms, and is not limited to apertures and/or fasteners that are received by the apertures.

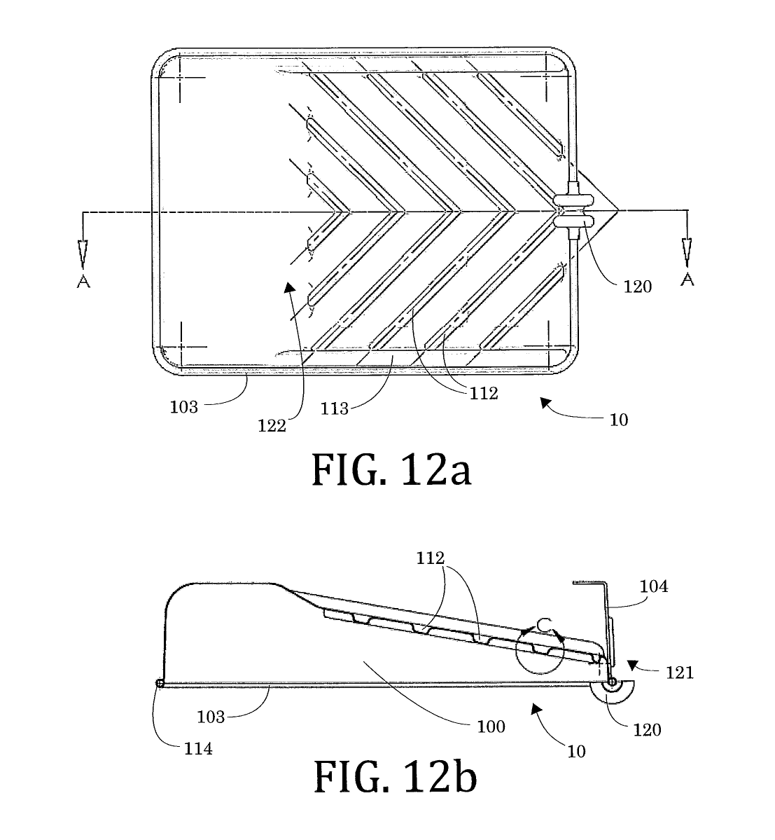

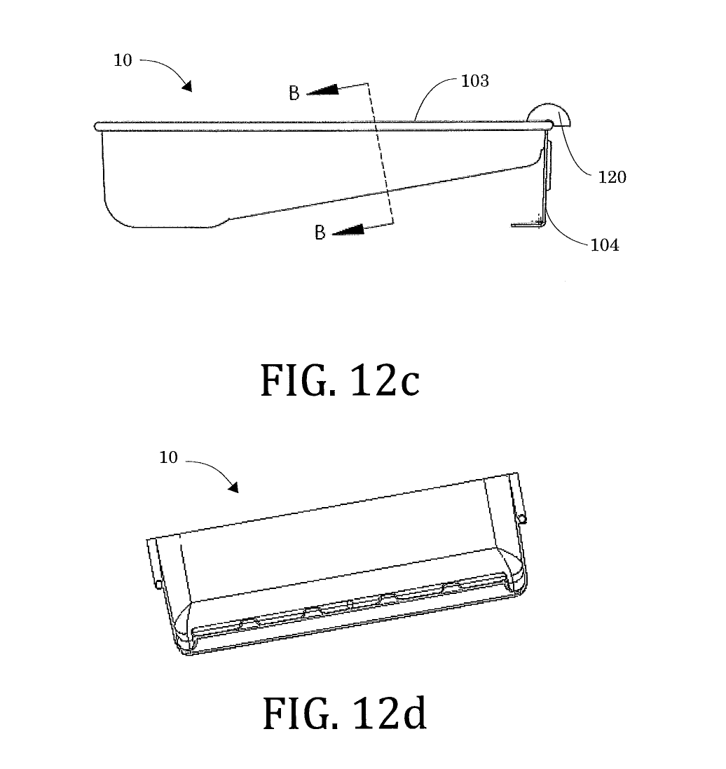

Referring now to FIGS. 12a-g, shown is a tray body 100 having a retaining member 120 according to a further preferred and non-limiting embodiment of the present invention. The retaining member 120 may be adapted to receive a handle of a paint roller and retain the paint roller in place at a position above the reservoir portion 101. The retaining member 120 may be substantially U-shaped, as depicted, or may take on any other number of forms. The retaining member 120 may be disposed on the rim 103 of one end of the tray body 100 adjacent the top of the sloped portion 102. FIG. 12b illustrates a sectional view of the line A-A through the paint tray 10 shown in FIG. 12a. Likewise, FIG. 12d illustrates a sectional view of the line B-B through the paint tray 10 shown in FIG. 12c. It is envisioned that all or a portion of the retaining member 120 is formed from or with a non-slip material or surface to further assist in retaining the paint roller in a substantially stationary position.

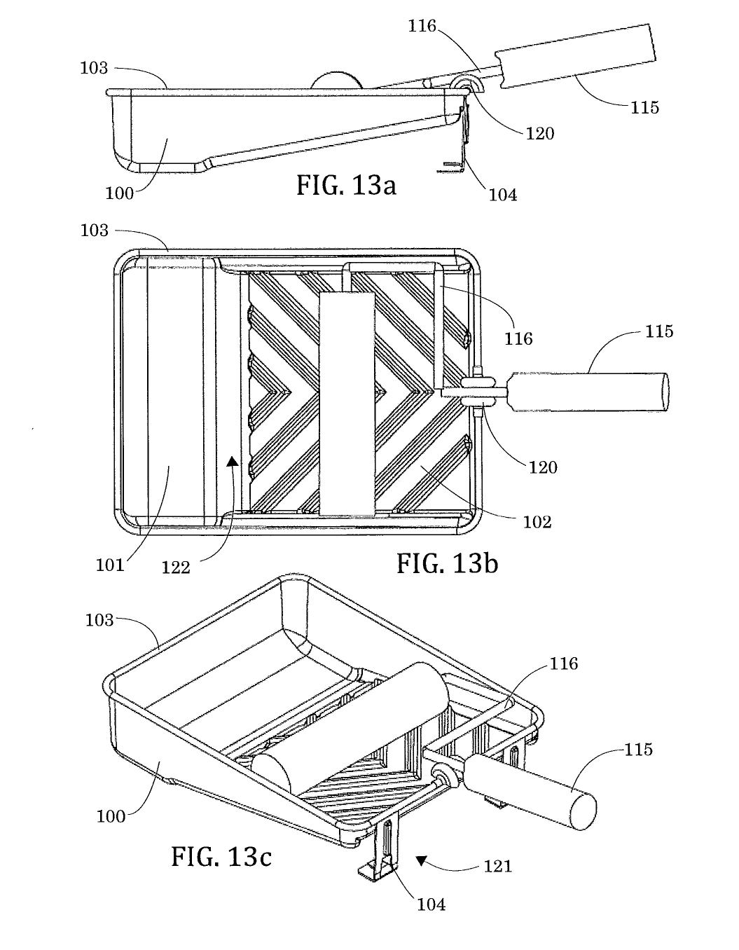

Referring to FIGS. 13a-c, shown is a tray body 100 having a retaining member 120 according to one preferred and non-limiting embodiment of the present invention. FIG. 13a is a side view of the paint tray 10, FIG. 13b is a top view of the paint tray, and FIG. 13c is a perspective view of the paint tray 10. As can be seen in FIGS. 13a-c, the retaining member 120 holds the paint roller 116 in place in a position on the sloped portion 102 of the tray body 100, with the handle 115 spaced away from the tray body 100.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A paint tray comprising:
a tray body;
at least one support structure; and
an attachment arrangement adapted for attaching the at least one support structure to at least one of an object and a surface.

2. The paint tray of claim 1, wherein the tray body includes at least one wall defining at least one inner surface, at least a portion of the at least one inner surface comprising a non-stick material.

3. The paint tray of claim 2, wherein the tray body further comprises a reservoir portion and a sloped portion, at least one of the reservoir portion and the sloped portion comprising at least a portion of the non-stick material.

4. The paint tray of claim 1, wherein the at least one support structure comprises the attachment arrangement.

5. The paint tray of claim 4, wherein the attachment arrangement comprises at least one aperture in the at least one support structure.

6. The paint tray of claim 1, wherein the tray comprises a rim, and wherein the rim comprises a substantially rigid portion.

7. The paint tray of claim 6, wherein the substantially rigid portion comprises at least one wire attached to, extending through, or embedded in the rim.

8. The paint tray of claim 1, wherein at least a portion of the tray body is formed from a substantially rigid metallic material.

9. A paint tray, comprising:
a tray body having a rim and at least one inner surface, wherein the rim comprises a substantially rigid portion; and
a plurality of substantially rigid ribs disposed on at least a portion of the at least one inner surface of the tray body.

10. The paint tray of claim 9, further comprising at least one leg having at least one attachment arrangement associated therewith.

11. The paint tray of claim 10, wherein the at least one attachment arrangement comprises at least one aperture.

12. The paint tray of claim 9, wherein the substantially rigid portion comprises at least one wire attached to, extending through, or embedded in the rim.

13. The paint tray of claim 9, wherein at least a portion of the paint tray is magnetic.

14. The paint tray of claim 9, wherein the at least one inner surface comprises at least one paint return channel adjacent the plurality of substantially rigid ribs.

15. The paint tray of claim 9, wherein at least a portion of the at least one inner surface comprises a non-stick surface.

16. The paint tray of claim 9, wherein the substantially rigid ribs have a height from about 1/16″ to about ⅜″.

17. A securable paint tray, comprising:
a tray body comprising an inner surface and a rim, the inner surface including a sloped portion and a reservoir portion, wherein at least a portion of the inner surface comprises a non-stick material;
a wire disposed within at least a portion of the rim; and
at least one support structure comprising an attachment arrangement.

18. The securable paint tray of claim 17, further comprising a plurality of substantially rigid ribs disposed on at least a portion of the sloped region.

19. The securable paint tray of claim 17, wherein the attachment arrangement comprises at least one aperture and at least one fastener configured to engage with or interact with the at least one aperture.

20. The securable paint tray of claim 19, wherein the at least one fastener comprises at least one of the following: pin, bolt, carriage bolt, quick-release assembly, screw, ball lock pin, or any combination thereof.
